(19) United States
(12) Patent Application Publication
(10) Pub. No.: US 2006/0026658 A1
(43) Pub. Date: Feb. 2, 2006

(54) Near-video-on-demand stream filtering

(76) Inventors: Wilhelmus Franciscus Johannes Verhaegh, Eindhoven (NL); Ronald Rietman, Eindhoven (NL); Johannes Henricus Maria Korst, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/536,638

(22) PCT Filed: Nov. 6, 2003
(86) PCT No.: PCT/IB03/05077

§ 371 Date: May 27, 2005

(30) Foreign Application Priority Data
Dec. 6, 2002 (EP) 02080102.3

(51) Int. Cl. H04N 7/16; H04N 7/173

(52) U.S. Cl. 725/101; 725/87; 725/28

(57) ABSTRACT

A broadcast system 100 for broadcasting at least one title using a near-video-on-demand broadcasting protocol includes a plurality of broadcast receivers 150. A hierarchical network of data distributors starts from a central distributor 110 through at least one layer of intermediate distributors 120, 130, 140 to the broadcast receivers for broadcasting the title as a sequence of data blocks. A least one filter controller 180 receives requests from broadcast receivers for the supply of the title and controls at least one intermediate distributor to filter out data blocks of the title that have not been requested by receivers hierarchically below the intermediate distributor.

### FIELD OF THE INVENTION

The invention relates to a broadcast system for broadcasting at least one title using a near-video-on-demand broadcasting protocol, where the system includes a plurality of broadcast receivers and a hierarchical network of data distributors starting from a central distributor through at least one layer of intermediate distributors to the broadcast receivers. The invention also relates to a method of broadcasting data streams. The invention further relates to a broadcast receiver, distributor and filter controller for use in such a system.

### BACKGROUND OF THE INVENTION

Conventional broadcasting systems, such as cable networks, for broadcasting data streams to a plurality of broadcast receivers use a hierarchical network of data distributors. The top of the network is formed by one central headend, the bottom layer of devices is formed by the residential broadcast receivers. As an example, a system aimed at broadcasting audio/video to a total of 200,000 homes may use a hierarchy of seven layers of devices. At the top, the master headend may supply data to five metropolitan headends, each covering a disjoint metropolitan area. Each of these areas may be divided further over five hubs with direct links between the metropolitan headend and the hubs. Each of the hubs may be directly connected to twenty fiber nodes from which in turn four coax cables are leaving. Each coax cable connects up to one hundred homes.

Typically the coaxial cable has a capacity in the order of one gigabit per second downstream (i.e. in the direction towards the broadcast receiver). Some of this capacity is reserved for conventional broadcast channels, like the most popular television stations. Such channels can in principle be received by all broadcast receivers (i.e. it is transmitted via all coax cables), although actual receipt may be conditional upon payment. A small part of the bandwidth tends to be reserved for upstream communication from the broadcast receiver up through the network to an interested party. Usually, this upstream communication is to the Internet, using broadband cable modems. It may also be to a service provider for interactive applications. With the remaining bandwidth, it is difficult if not infeasible to provide an effective video-on-demand service where a significant portion of the receivers can simultaneously receive a title (e.g. movie) whose supply is started substantially immediately after the user having indicated that it wishes to receive the title. To overcome this, so-called near-video-on demand broadcast distribution protocols have been developed wherein a title is repeatedly broadcast using a group of a plurality of broadcast channels. A highly effective protocol is the Pagoda broadcasting protocol described in “A fixed-delay broadcasting protocol for video-on-demand”, of J.-F. Pâris, Proceedings of the 10^{th} International Conference on Computer Communications and Networks, pages 418-423. In this protocol, after an initial delay of, for example, one minute the broadcast receiver can render the title in real-time by retrieving the blocks from a plurality of channels where the protocol prescribes in which channel a block is transmitted and the sequence of transmission of blocks in a channel. Typically, the receiver needs to tap a few of the group of channels (e.g. two channels) to avoid underflow of data. The repetition rate of the first channel is the highest, resulting in a relatively low initial delay. The repetition rate of the last channel is the lowest (this channel can be used to transmit most different blocks). To support simultaneous transmission of a large collection of near-video-on demand movies (e.g. 1000 movies) the broadcast system needs a high bandwidth. For the levels between the master headend and the fiber nodes this can easily be achieved using suitable dedicated links, such as using fiber optic based distribution. Particularly at the lowest level, use of a shared medium, such as coax, is most economical. The bandwidth of the shared medium is not sufficient for broadcasting of a relatively large number of near-video-on-demand titles. This hampers the introduction of such systems.

### SUMMARY OF THE INVENTION

It is an object of the invention to provide a near-video-on-demand system and devices used in such system that can support broadcasting of more titles.

To meet the object of the invention, a broadcast system for broadcasting at least one title using a near-video-on-demand broadcasting protocol includes a plurality of broadcast receivers; a hierarchical network of data distributors starting from a central distributor through at least one layer of intermediate distributors to the broadcast receivers for broadcasting the title as a sequence of data blocks; and at least one filter controller operative to receive requests from broadcast receivers for the supply of the title and for controlling at least one intermediate distributor to filter out data blocks of the title that have not been requested by receivers hierarchically below the intermediate distributor. By filtering out blocks that are not required, capacity is freed at the network below the intermediate distributor. This capacity can be used by the central distributor to broadcast more titles. The filter controller monitors which titles are required by the lower network segments and controls the filtering accordingly.

As described by the measure of the dependent claim 2, data blocks of the title are broadcast via a plurality of channels using sequential time-slots within the channels according to a near-video-on-demand schedule that for each data block of the title prescribes a time-slot and channel for broadcasting the data block relative to a time-slot used for broadcasting a first data block of the title; data blocks assigned to a channel being repeatedly broadcast within the channel; the filter controller being operative to: store information on all receivers hierarchically below the intermediate distributor that have requested the title (hereinafter “interested receivers”) to enable the filter controller to determine for each channel whether at least one of the interested receivers needs to receive a data block assigned to the channel; and control the intermediate distributor to filter out a channel if no interested receiver needs to receive a data block assigned to the channel. The filter controller stores information on the interested receivers, such as the time-slot in which it started reception of the title and/or the current time-slot and/or data block being received. Such information enables the filter controller to determine whether or not a channel needs to be broadcast (it needs to be broadcast if at least one interested receiver is still tapping it). If no interested receiver is tapping a channel, the entire channel can be filtered out and used for other purposes for example for broadcasting another near-video-on demand title.

As described by the measure of the dependent claim 3, the near-video-on-demand schedule prescribes that data blocks of the title are broadcast via c parallel equal capacity channels of the broadcast system, where each broadcast channel is associated with a respective sequential channel number; the title being divided in a plurality of consecutive data block sequences; each block sequence being assigned to one respective channel according to the sequence of the channel numbers; each channel repeatedly broadcasting the assigned block sequence; the broadcast receiver having a capacity to simultaneously receive a plurality r (1<r≦c) of the channels; the broadcast receiver being operative to receive a title by starting reception of the sequentially lowest r channels and each time in response to having received all blocks of the block sequence of a channel i terminating reception of channel i and starting reception of channel r+i until all block sequences have been received. Such a Pagoda-style broadcasting schedule enables the filter controller to simply determine for each channel whether or not a data block is required in the next time-slot purely based on the first time-slot used by the receivers. As such, the filter controller only needs to know the start of reception and needs no continuous flow of information from the receivers to be able to control the filtering on a channel level.

As described by the measure of the dependent claim 4, the Pagoda-style broadcasting schedule enables the filter controller to even filter at a sub-channel level, where a channel is divided in time-multiplexed sub-channels.

Similarly, as described by the measure of the dependent claim 5, the Pagoda-style broadcasting schedule enables the filter controller to even filter at a data block level.

As described by the measure of the dependent claim 6, the channels are time-multiplexed. By time-multiplexing the channels, re-use of the channel is simplified. In fact, filtering out a channel, sub-channel or individual block all result in freeing up one or more time-slots that can be re-used for other purposes.

As described by the measure of the dependent claim 7, the intermediate distributor is operative to extract data blocks broadcast via the r channels to be received by at least one interested receiver and transmit the extracted data blocks via predetermined channels to the interested receivers. Particularly if a title is not received by many receivers using different time-slots, this is an effective way of reducing N channel to only r channels. All the remaining N-r channels used for the title can be filtered out.

As described by the measure of the dependent claim 8, the intermediate distributor includes the filter controller. This simplifies interaction between both parties.

As described by the measure of the dependent claim 9, at least one of the broadcast receivers is operative to communicate to the filter controller via an upstream channel of the broadcast system. Using the upstream channel is an effective way of communicating with the filter controller. Particularly if the filter controller is combined with the intermediate distributor up-stream communication can simply be intercepted by the filter controller without the broadcast receiver requiring any knowledge of the network topology and/or location of the distributor(s) and/or filter controller(s).

These and other aspects of the invention are apparent from and will be elucidated with reference to the embodiments described hereinafter.

### BRIEF DESCRIPTION OF THE DRAWINGS

In the drawings:

FIG. 1 shows an exemplary hierarchical broadcast network in which the invention can be employed;

FIG. 2 shows block diagram of the broadcast system according to the invention;

FIGS. 3A and 3B illustrate the Pagoda NVoD protocol;

FIG. 4 illustrates adding a channel in the Pagoda protocol;

FIG. 5 illustrates the blocks actually read by the receivers;

FIG. 6 shows the expected number of used channels for one movie;

FIG. 7 shows a Markov chain that describes the states of a minimal transmission scheme;

FIG. 8 shows a lower bound on the expected number of channels needed for a movie;

FIG. 9 shows a second bound on the expected number of channels needed for a movie based on optimal block periods and selective transmission;

FIG. 10 compares the graphs of FIGS. 6, 8 and 9; and

FIG. 11 shows the ratio between the two selective transmission schedules and the lower bound.

### DETAILED DESCRIPTION OF THE PREFERRED EMBODIMENT

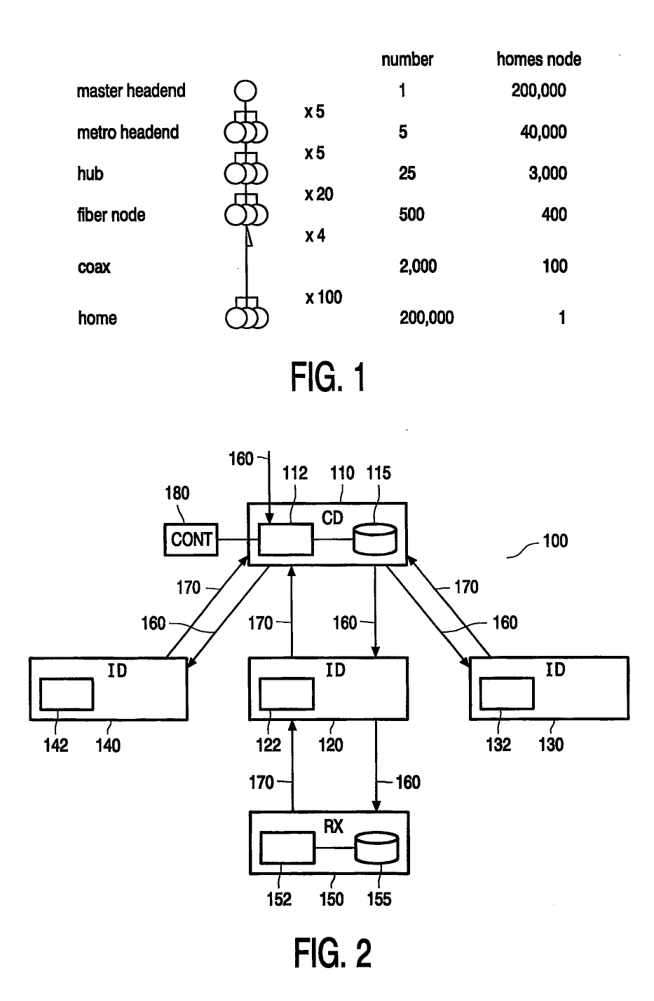

FIG. 2 shows a block diagram of the broadcast system according to the invention. The broadcast system 100 includes a hierarchical network of data distributors. The top of the network is formed by a central distributor 110. The system includes at least one layer of intermediate distributors. To simply the figure, only one intermediate layer for downstream broadcasting is shown with three intermediate distributors 120, 130 and 140, each covering a disjoint geographical area. FIG. 1 shows a typical hierarchical network for a town of 200,000 connected homes, with three intermediate downstream layers (metro headend, hub, fiber node). In the example, four coax segments are connected to each fiber node. FIG. 2 also indicates the downstream path 160 that starts at the central distributor 110, runs through the intermediate distributors 120, 130 and 140 and ends at the plurality of broadcast receivers of the system. Conventionally the distributors split the broadcast signal towards the receivers/distributors that are hierarchically one layer lower. For simplicity only one broadcast receiver 150 is shown. Typically, the path is divided into a plurality of channels, that each may be sub-divided into sub-channels. At the lowest level, usually coaxial segments are used that form a shared medium to the broadcast receivers. On coax, channels are usually frequency multiplexed. Sub-channels within such a channel may be time-multiplexed. At the higher levels, typically fiber optics is used. On such media, channels may also be time-multiplexed. Any suitable transmission technology, such as various types of media and multiplexing techniques, may be used. The broadcast system is described for broadcasting digital data streams through the network to the plurality of broadcast receivers using a near-video-on-demand protocol (NvoD). The data streams may have been encoded using any suitable technology, such as MPEG2 video encoding. Broadcast data is not addressed to a specific receiver and can in principle be received by all receivers in all segments of the hierarchical network. Access to the data may be subject to payment. In the broadcast system according to the invention access may also be controlled using suitable conditional access mechanisms. For each device of the system, FIG. 2 schematically shows the respective hardware/software functionality 112, 122, 132, 142 and 152 necessary for sending/receiving broadcast data and performing all necessary processing. In itself such HW/SW is known and can be used for the system according to the invention. The HW/SW may be formed by suitable transceivers (such as fiber optics transceiver and/or cable modems) controlled by using suitable processors, such as signal processors. Also dedicated hardware, like MPEG encoders/decoders, buffers, etc. may be used.

Traditionally, all data streams are inserted by the central distributor 110 and unmodified copied by each intermediate layer to the lowest part of the network (i.e. the signal is split). For the insertion, the central distributor may have a storage 115 for storing a plurality of titles, such as movies. It may also have a connection 160 for receiving live broadcasts, e.g. through satellite connections. The storage may be implemented on suitable server platforms, for example based on RAID systems. The receiver also has access to a storage 155. This storage may also be formed by a hard disk or solid state memory, such as RAM of flash memory. The storage is used for (temporarily or permanently) storing the entire title or part of the title received via the downstream channels before the title is rendered. FIG. 2 also shows an upstream channel 170 of the network towards the central distributor. In principle, the upstream channel may start at an intermediate level going upwards. Preferably, the upstream channel is already present at the lowest level, also allowing communication to outside the broadcast system (e.g. towards the Internet via the central distributor or an intermediate distributor outwards).

Filtering

To support simultaneous transmission of a large collection of near-video-on demand movies (e.g. 1000 movies) the broadcast system needs a high bandwidth. For the levels between the master headend and the fiber nodes this can easily be achieved using suitable dedicated links, such as using fiber optic based distribution. Particularly at the lowest level, use of a shared medium, such as coax, is most economical. By selectively filtering data according to the invention, for example in the fiber optic node, and only passing on data for which there is at least one interested receiver the bandwidth can be sufficient for simultaneous distribution of a relatively large number of movies. Note that also at higher levels in the network already a selection can be made, e.g., a hub only has to forward the blocks of the movies that will be consumed by any user in its sub-tree; the others do not have to be forwarded.

To be able to filter, the system includes at least one filter controller operative to controlling at least one intermediate distributor to filter out data blocks of the title that have not been requested by receivers hierarchically below the intermediate distributor. FIG. 2 shows one central filter controller 180. Preferably, the system includes a plurality of filter controllers, where advantageously each filter controller controls one intermediate distributor and may be combined with it. For the filter controller to be able to determine whether there are receivers that need certain data blocks of a title, it directly or indirectly receives requests from broadcast receivers for the supply of the title. Preferably, it receives this information directly from the receiver via an upstream channel of the network. Depending on the NVoD protocol being used, it may be sufficient for the filter controller to know the start (e.g. time-slot of first block) of reception by each receiver that is part of the network segment controlled by the controller. This is for example the case with fixed-delay NVoD broadcasting schedules, such as Pagoda. Such schedules prescribe for each data block of the title a time-slot and channel (and/or sub-channel within the channel) for broadcasting the data block relative to a time-slot used for broadcasting a first data block of the title. For other schedules, it may be required that the filter controller is more regularly updated on the blocks required by the receivers. The filter controller stores information on all receivers hierarchically below the intermediate distributor that have requested the title (hereinafter “interested receivers”) to be able to determine for each channel whether at least one of the interested receivers needs to receive a data block assigned to the channel at each point in time. For the described fixed-delay schedules, the filter controller only needs to store the time-slot of the first data block consumed by the receiver. Since these schedules prescribe the entire block transmission schedule, in principle also other information, such as the block currently being consumed, is sufficient to determine if in the next time-slot the receiver needs data block(s) and, if so, via which channel/sub-channel. Filtering may take place in several ways, e.g. broadcasting via a channel may be stopped for one or more blocks or broadcasting via a sub-channel may be stopped for one or more blocks. The filtering may take place for each individual time-slot or only for sequences of time-slots, e.g. that correspond to a sequence of blocks of a title being repeatedly broadcast via a channel or sub-channel. The filter controller may instruct the intermediate distributor for each time-slot whether or not to pass on a data block received from the central distributor. It will be appreciated that bandwidth saved by filtering out (sequences of) blocks can be re-used. Re-use may be particularly simple if channels in the system are time-multiplexed. For such systems, typically time-slots that are not used can be used for other purposes, e.g. for other isochronous channels (either broadcast, multi-cast or directly addressed) or for asynchronous data. For systems that use frequency multiplexed channels, the filter controller may instruct the intermediate distributor how to map the (too many) incoming channels to the fewer outgoing channels. For filtering of small sequences (or even individual blocks), the filter controller may need to inform the broadcast receivers (e.g. via a directly addressed message) on which frequency it can receive the channels. Particularly for the fixed delay schedules, the filter controller can regularly calculate such a mapping of channels to frequencies. It may even broadcast such a schedule to the receivers.

In a preferred embodiment, the intermediate distributor may compose channels for one or more of the receivers from the streams broadcast to the distributor. This is particularly effective if there are relatively few receivers interested in the title at that moment and/or if they are watching almost the same sequence. To this end, the distributor extracts data blocks of a title required by the receivers from a group of channels dedicated to the title and re-broadcasts them towards the receivers using fewer channels. In the examples given below for the Pagoda schedule this may involve extracting blocks from c channels assigned to the title and re-broadcasting the blocks using only r channels.

The filtering according to the invention will be described with reference to the Pagoda NVoD broadcasting protocol. Persons skilled in the art will be able to apply the same principles to other schedules as well.

Fixed-Delay Pagoda Broadcasting

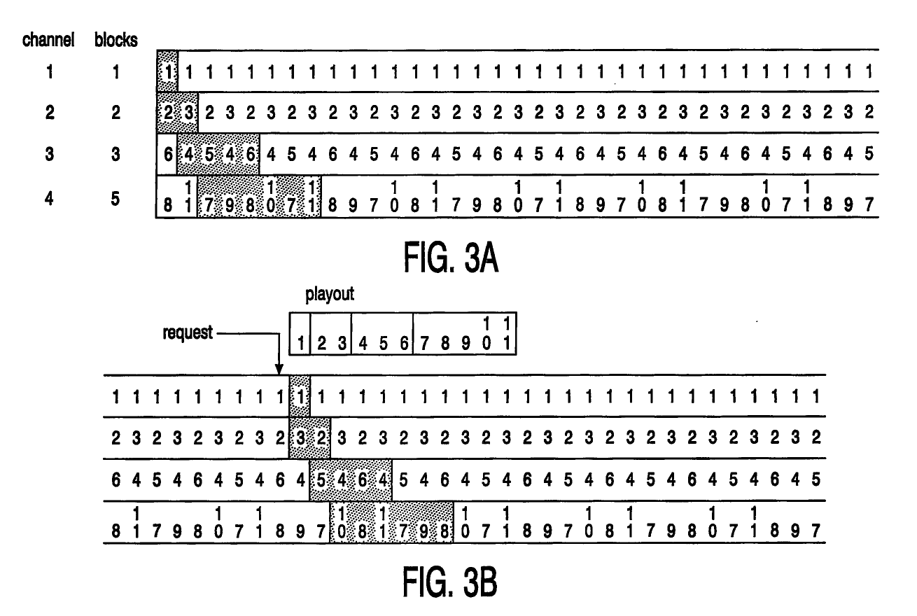

Preferably, the fixed-delay Pagoda broadcasting protocol is used as the near-video-on-demand protocol for broadcasting data blocks of the titles. This protocol is asymptotically optimal, and it can easily be adapted to limited client I/O bandwidth. A small example of this is given in FIG. 3A. FIG. 3B shows how the retrieval takes place for a request at an arbitrary moment. In the example of FIG. 3, at most two channels are tapped at the same time, and all blocks arrive in time. Key in this NVoD scheme is that channel i starts being tapped after the tapping of channel i−2 has finished, thereby limiting the number of channels to be tapped to two. This means e.g. that for channel 4 a receiver has to wait two time units before it can start tapping the channel. As block 7 has to be received within 7 time units after the request, this means that only 5 time units are left to receive it, and hence it has to be transmitted with a period of at most 5, rather than 7. It is actually transmitted with a period of 4. The general structure of the above broadcast scheme will be described for a given number c of server channels and a given number r of client channels that can be received. Furthermore, an offset o is considered as described meaning that a user will always wait an additional o time units before playing out. The start of the (tapping) segment in channel i is denoted by sᵢ, and the end by eᵢ. Then, in order not to exceed the maximum number r of channels that a user can receive, tapping in channel i=r+1, . . . , c is started after the tapping in channel i−r has ended. Hence

$${s}_{i} = \{ \begin{matrix}1 & for i = 1 , … r \\ {e}_{i - r} + 1 & for i = r + 1 , … , c\end{matrix}$$

Next, in channel i blocks lᵢ, . . . , hᵢ are transmitted. The number of different blocks transmitted in channel i is hence given by nᵢ=hᵢ−lᵢ+1, and

$${l}_{i} = \{ \begin{matrix}1 & for i = 1 \\ {h}_{i} + 1 & for i > 1\end{matrix}$$

In order to receive each block in time, block k is to be transmitted in or before time unit o+k. If block k is transmitted in channel i, which starts being received in time unit se, this means that block k should be broadcast with a period of at most o+k−(sᵢ−1). Ideally, this period is exactly met for each block k, but it is sufficient to get close enough.

The structure of channel i in the pagoda scheme is as follows. First, channel i is divided into a number di of sub-channels, which is given by
dᵢ=└\sqrt{o+lᵢ−(sᵢ−1)}┘ (1)
i.e., the square root of the optimal period of block lᵢ, rounded to the nearest integer. Each of these sub-channels gets a fraction 1/dᵢ of the time units to transmit blocks, in a round-robin fashion. In other words, in time unit t sub-channel t mod dᵢ can transmit a block, where we number the sub-channels 0, 1, . . . , dᵢ−1.

Now, if a block k is given a period pₖ within a sub-channel of channel i, it is broadcasted in channel i with a period of pₖdᵢ. Hence, to obtain that pₖdᵢ≦o+k−(sᵢ−1), this means that

$${p}_{k} \leq [ \frac{o + k - ( {s}_{i} - 1 )}{{d}_{i}} ]$$

By taking equal periods for all blocks within each sub-channel, collisions can be trivially avoided. So, if lᵢⱼ is the lowest block number in sub-channel j of channel i, this means that the following period is chosen

$${p}_{ij} = ⌊ \frac{o + {l}_{ij} - ( {s}_{i} - 1 )}{{d}_{i}} ⌋$$

for all blocks within sub-channel j of channel i, and hence we can transmit nᵢⱼ=pᵢⱼ blocks (blocks lᵢⱼ, . . . , lᵢⱼ+nᵢⱼ−1) in this sub-channel. The block number is, is given by

$${l}_{ij} = \{ \begin{matrix}{l}_{i} & for j = 0 \\ {l}_{i , j - 1} + {n}_{i , j - 1} & for j > 1\end{matrix}$$

The total number nᵢ of blocks transmitted in channel i is then given by

$${n}_{i} = {\sum }_{j = 0}^{{d}_{i} - 1} {n}_{ij}$$

with which we can compute hᵢ=lᵢ+nᵢ−1.

Finally, the moment of start and end of the segments within a channel is reviewed. All sub-channels of channel i start transmitting at time sᵢ. Sub-channel j of channel i is ready after nᵢⱼ blocks, which takes dᵢnᵢⱼ time units within channel i. Hence, the end of the segment in sub-channel j is given by eᵢⱼ=sᵢ−1+dᵢnᵢⱼ, and channel i ends when its last sub-channel ends, at
eᵢ=e_{i,d}_{ᵢ}₋₁=sᵢ−1+dᵢn_{i,d}_{ᵢ}₋₁

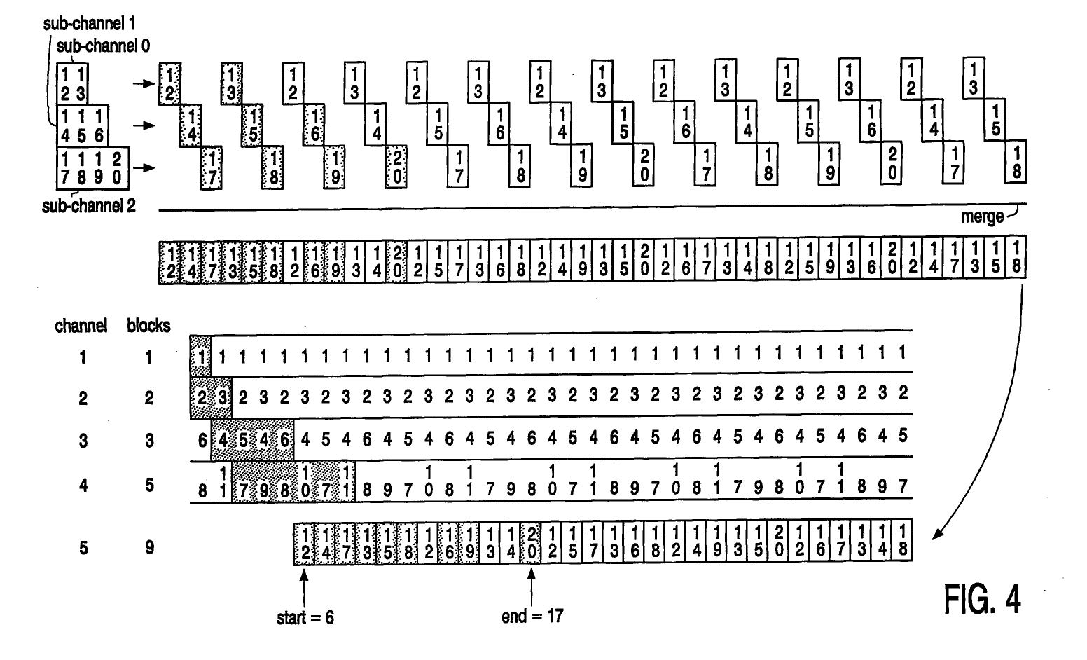

To exemplify the above, FIG. 4 illustrates adding a fifth channel to the example of FIG. 3. For the fifth channel, the following holds: l₅=12, s₅=e₃+1=6, and an offset o=0. The number of sub-channels is d₅=[√(0+12−5)]=3. For sub-channel j=0 this gives l_{5,0}=12, hence we can transmit n_{5,0}=└(0+12−5)/3┘=2 blocks in this sub-channel, being blocks 12 and 13. For sub-channel j=1 this gives l_{5,1}=14, hence we can transmit n_{5,1}=└(0+14−5)/3┘=3 blocks in this sub-channel, being blocks 14, 15, and 16. For sub-channel j=2 this gives l_{5,2}=17, hence we can transmit n_{5,2}=└(0+17−5)/3┘=4 blocks in this sub-channel, being blocks 17, 18, 19, and 20. The end of the segments in the sub-channels are given by e_{5,0}=5+3*2=11, e_{5,1}=5+3*3=14, and e_{5,2}=5+3*4=17, hence e₅=17.

The values of hᵢ, i.e., the number of blocks in which a movie can be split, are given in table 1 for an offset zero and for different values of r. The series converge to power series, with bases of about 1.75, 2.42, 2.62, and e=2.72, for r=2, 3, 4, and ∞, respectively.

TABLE 1

| | r = 2 | r = 3 | r = 4 | r = ∞ |
|---|---|---|---|---|
| i = 1 | 1 | 1 | 1 | 1 |
| i = 2 | 3 | 3 | 3 | 3 |
| i = 3 | 6 | 8 | 8 | 8 |
| i = 4 | 11 | 17 | 20 | 20 |
| i = 5 | 20 | 39 | 47 | 50 |
| i = 6 | 38 | 86 | 113 | 124 |
| i = 7 | 68 | 198 | 276 | 316 |
| i = 8 | 122 | 467 | 692 | 822 |
| i = 9 | 221 | 1102 | 1770 | 2176 |
| i = 10 | 397 | 2632 | 4547 | 5818 |
| i = 11 | 708 | 6308 | 11800 | 15646 |
| i = 12 | 1244 | 15192 | 30748 | 42259 |
| i = 13 | 2195 | 36672 | 80273 | 114420 |
| i = 14 | 3862 | 88710 | 210027 | 310284 |
| i = 15 | 6757 | 214792 | 549998 | 842209 |

The last column corresponds to having no limit on the number of client channels. Using the above values of h_{c}, the maximum waiting time is given by a fraction 1/h_{c} of the movie length when using c channels. If a positive offset o is used, the general formula for the maximum waiting time is a fraction (o+1)/h_{c} of the movie length.

In the previous sections, the number dᵢ of sub-channels of channel i is fixed, given by equation (1). It should be noted that also different values may be used to get a better solution in terms of the number of blocks into which a movie can be split. To this end, a first-order optimization can be applied by exploring per channel i a number of different values around the target value given in (1), calculating the resulting number of blocks that can be fit into channel i, and taking the number of sub-channels for which channel i can contain the highest number of blocks. Note that this is done per individual channel, i.e., no back-tracking to previous channels occurs, to avoid an exponential run time for a straightforward implementation. This may lead to sub-optimal solutions, as choosing a different number of sub-channels in channel i to get a higher number of blocks in it may cause the end time e, to increase, thereby increasing the start time sᵢ₊ᵣ of channel i+r, which may in turn decrease the number of blocks that can be fit into this channel. Nevertheless, this first-order optimization gives good results as is shown in table 2. The new values of hᵢ are given for an offset zero and for different values of r. Although the numbers are higher than the ones in the previous table, the bases of the power series are the same as those of table 1.

TABLE 2

| | r = 2 | | r = 3 | | r = 4 | | r = ∞ | |
|---|---|---|---|---|---|---|---|---|
| i = 1 | 1 | | 1 | | 1 | | 1 | |
| i = 2 | 3 | | 3 | | 3 | | 3 | |
| i = 3 | 6 | | 8 | | 8 | | 8 | |
| i = 4 | 11 | | 18 | (+1) | 20 | | 20 | |
| i = 5 | 21 | (+1) | 41 | (+2) | 47 | | 50 | |
| i = 6 | 42 | (+4) | 94 | (+8) | 115 | (+2) | 127 | (+3) |
| i = 7 | 81 | (+13) | 218 | (+20) | 287 | (+11) | 328 | (+12) |
| i = 8 | 148 | (+26) | 510 | (+43) | 728 | (+36) | 859 | (+37) |
| i = 9 | 269 | (+48) | 1213 | (+111) | 1868 | (+98) | 2283 | (+107) |
| i = 10 | 478 | (+81) | 2908 | (+276) | 4831 | (+284) | 6112 | (+294) |
| i = 11 | 841 | (+133) | 6993 | (+685) | 12543 | (+743) | 16459 | (+813) |
| i = 12 | 1487 | (+243) | 16869 | (+1677) | 32685 | (+1937) | 44484 | (+2225) |
| i = 13 | 2627 | (+432) | 40749 | (+4077) | 85391 | (+5118) | 120485 | (+6065) |
| i = 14 | 4617 | (+755) | 98625 | (+9915) | 223390 | +13363) | 326795 | +16511) |
| i = 15 | 8058 | (+1301) | 238841 | (+24049) | 584993 | (+34995) | 887124 | (+44915) |

In the remainder, the values of table 1 for the conventional Pagoda protocol will be used.

In the description so far, it has been assumed that titles have a constant bit rate (CBR). The transmission schemes, however, can easily be adapted to cope with variable bit rate (VBR) streams. The time at which block k must have arrived, which is given by o+k for CBR streams, is then given by a function o+t(k). Here, t(k) is an increasing function, that describes the way the stream is to be played out in time. The effect on the transmission scheme is as follows. If block k is transmitted in channel i, which starts at time sᵢ, then it must be broadcasted with a period of at most o+t(k)−(sᵢ−1). Hence, the target value for the number of sub-channels, as given in equation (1), now becomes
dᵢ=└\sqrt{o+t(lᵢ)−(sᵢ−1)}┘

The number of blocks in sub-channel j of channel i, i.e., the period used within this sub-channel, is then given by

$${n}_{ij} = {p}_{ij} = ⌊ \frac{o + t ( {l}_{ij} ) - ( {s}_{i} - 1 )}{{d}_{i}} ⌋ .$$

The rest of the computations remain the same.

Network Assumptions

In the remainder, examples are given for a hierarchical network as shown in FIG. 1. It is assumed that the main bottleneck is given by the capacities of the upstream and downstream links from the homes to the fiber nodes. In the example, it is assumed that the capacities of the downstream links from the fiber nodes to the homes is 20 Mb/s. Assuming a video transmission rate of 5 Mb/s, this implies that 4 video channels can be downstreamed per home. In the examples, it is assumed that there are no practical limitations on bandwidth above the fiber nodes. Further, it is assumed that it is desired to have a collection of 1000 movies, which each last 6000 seconds (100 minutes). The size of a movie is hence 30 Gb, or 3.75 GB. Aiming at a maximum response time of about one second, and a limit of r=3 channels to be tapped, table 1 indicates that 11 transmission channels should be used, where a movie can be split into 6308 blocks, and the actual maximum response time is 6000/6308=0.95 s. Generating the 11 transmission channels of all 1000 movies would use 55 Gb/s. It will be clear that this well above the capacity of the lowest level of the network where the capacity is in the order of 1.5 Gb/s.

Filtering According to the Invention

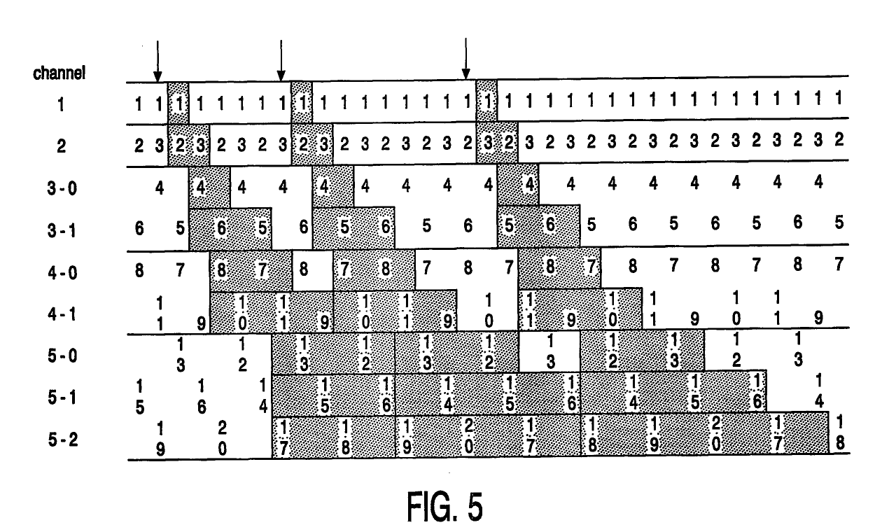

A drawback of the conventional Pagoda NVoD broadcasting scheme, or other similar NVoD schemes, is that all titles are continuously broadcast in full occupying a lot of bandwidth. This may not be a major problem for popular movies, with many receivers receiving the title, but can be a significant waste of bandwidth for unpopular titles. In the known systems, unpopular movies get the same amount of bandwidth allocated as popular movies. According to the invention, the number of used channels is decreased by not transmitting blocks that are not required to serve a user request. FIG. 5 illustrates for three initial user requests, indicated by the arrows, the blocks that are actually read by the receivers, using the Pagoda schedule. Those blocks are indicated in gray. All other blocks are broadcast but not consumed, wasting bandwidth. It is observed that in Pagoda-like schedules, a receiver only taps a channel between the receiver-specific start and end time. All other repetitions of the block sequence assigned to the channel are not received by that receiver (but possibly by other receivers). The same observation applies at the sub-channel level, i.e., each sub-channel only has to be tapped by a receiver between the specific start and end time for the receiver for that sub-channel. As a consequence, a block only has to be transmitted if it falls within read interval for a certain request (i.e. at least one receiver requires a sequence or block of the sequence transmitted via the block/sub-channel or channel). If there is no such request, the block does not need to be transmitted, and the bandwidth can be used for other purposes. As a result, the average number of channels used simultaneously can be much lower than the worst case number of 11,000. So, if a request occurs at time t, then sub-channel j of channel i should be active from time unit t+sᵢ until time unit t+eᵢⱼ, i.e., at time units x for which t+sᵢ≦x≦t+eᵢⱼ. The other way around, if at a time unit x it is sub-channel j's turn, then it has to transmit a block if and only if there has been a request at a time t for which x−eᵢⱼ≦t≦x−sᵢ.

The probability of a request of any user in a time unit for a movie f is denoted by p_{f}. If in a certain time unit it is the turn of sub-channel j of channel i, then the probability that it needs to transmit a block is given by
p_{fij}=1−(1−p_{f})^{e}^{ᵢⱼ}^{-s}^{ᵢ}⁺¹=1−(1−p_{f})^{d}^{ᵢ}ⁿ^{ᵢⱼ},
assuming the requests in different time units to be independent. For the example of FIG. 5, this gives
p_{f,3,0}=1−(1−p_{f})²
p_{f,3,1}=1−(1−p_{f})⁴,
as d₃=2, n_{3,0}=1, and n_{3,1}=2, which corresponds to the probability of an arrival in an interval of two time units and four time units, respectively. The expected fraction of the blocks that channel i of movie f has to transmit is hence given by

$${E}_{fi} = {\sum }_{j = 0}^{{d}_{i} - 1} \frac{{p}_{fij}}{{d}_{i}} ,$$

and the expected total number of channels that have to transmit a block for movie f is given by

$${E}_{f} = {\sum }_{i = 1}^{c} {E}_{fi} .$$

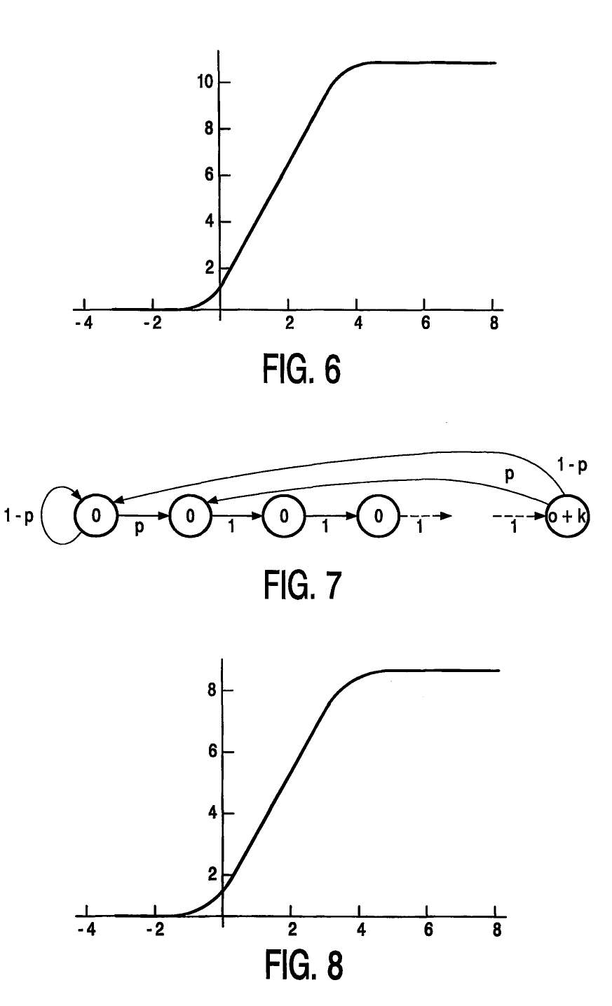

Now, assuming a Poisson arrival process with parameter A, then the arrival probability in a time unit is given by
p_{f}=1−e^{-λu},
where u is the length of a time unit. FIG. 6 shows vertically the expected number of used channels for one movie, for different arrival rates of 10^{x} receivers per hour (x is shown horizontally), on a logarithmic scale.

Assuming 1000 movies, of which 31, 115, 200, 285, and 369 movies have a probability of 0.01, 0.0316, 0.001, 0.00316, and 0.0001, of being selected, respectively, and we assume an arrival rate of 200,000 requests per 6,000 seconds, then the expected total number of used channels is about 5,533 compared to 11,000. If the arrival rate is decreased by a factor 10, for instance since not all users will watch a movie, the number goes even further down to 2,858.

In an ideal situation, with respect to the average number of used channels, a new transmission of a block k is scheduled as late as possible. Note that whereas this schedule gives the lowest average number of used channels, it does not bound the maximum number of used channels, which makes it less-suitable for practical use. It is therefore only used to derive a lower bound on the number of used channels. This means that if a new request arrives in time unit t, block k is scheduled for transmission in time unit t+o+k, the time unit in which it is needed for playout. In this way, all requests that arrive in time units t+1, . . . , t+o+k−1 can tap this transmission of block k, i.e., the considered transmission of block k can be reused for as many other requests as possible. Only when a new request arrives in time unit t+o+k or later, a new transmission of block k is scheduled. The fraction of time that block k is transmitted is now determined, again assuming a Poisson arrival rate of λ and a time unit of length u. As derived before, the probability that a request arrives in a time unit then equals
p=1−e^{-λu}.

The above procedure can be modeled by means of a Markov chain, as indicated in FIG. 7. In this chain, a state 0 is defined when the system is waiting for a new request. When a request has arrived, counting starts from 1 to o+k, hence states 1, . . . , o+k are introduced. If the system is in state 0, counting starts when a request arrives, which happens with probability p. If this happens, a transition is made to state 1, otherwise the system stays in state 0. If the system is in state s=1, . . . , o+k−1, counting continues, hence the next state is state s+1 with probability 1. If the system is in the last state o+k, a transmission takes place. If in this same time unit a new request arrives, which again happens with probability p, then counting is re-started, i.e., the system goes to state 1 again. Otherwise, it goes to the waiting state 0.

The probability that the system is in state s in equilibrium is indicated by pₛ. Looking at the chain, it can be observed that every time state 1 is reached also states 2, . . . , o+k will be reached, hence it holds that
p1=p2= . . . =pₒ₊ₖ

Next, considering the transitions from and to state 0, this gives
pₒ*p=pₒ₊ₖ*(1−p),
hence

$${p}_{0} = \frac{1 - p}{p} {p}_{o + k} = ( \frac{1}{p} - 1 ) {p}_{o + k} .$$

The sum of the probabilities has to be 1, so

$${p}_{o + k} ( \frac{1}{p} - 1 + o + k ) = 1 ,$$

which gives

$${p}_{o + k} = {( \frac{1}{p} - 1 + o + k )}^{- 1} .$$

This is the fraction of time that block k is transmitted, hence, if a movie consists of n blocks, the average number of used channels given by

$${\sum }_{k = 1}^{n} {( \frac{1}{p} - 1 + o + k )}^{- 1}$$

Choosing the size u of a time unit very small, and assuming a maximum waiting time of w and length l of a movie, then we have o≈w/u, n≈l/u, and p=1−e^{-λu}, which gives an average number of used channels given by

$${\sum }_{k = 1}^{l / u} {( \frac{1}{1 - {ⅇ}^{- λ u}} - 1 + w / u + k )}^{- 1} .$$

For sufficiently small u, this can be approximated by

$${\int }_{0}^{l / u} {( \frac{1}{1 - {ⅇ}^{- λ u}} - 1 + w / u + x )}^{- 1} ⅆ x .$$

As ∫ₒ^{b}(a+x)⁻¹dx=ln((a+b)/a), this can be rewritten into

$$ln ( \frac{\frac{1}{1 - {ⅇ}^{- λ u}} - 1 + w / u + l / u}{\frac{1}{1 - {ⅇ}^{- λ u}} - 1 + w / u} ) = ln ( \frac{u + ( w + l ) ( {ⅇ}^{λ u} - 1 )}{u + w ( {ⅇ}^{λ u} - 1 )} ) .$$

If u↓0, this converges to

$$ln ( \frac{1 + λ ( w + 1 )}{1 + λ w} ) .$$

FIG. 8 shows this lower bound on the average number of used channels (vertically) for the same maximum response time w=0.95 s and the same movie length l=6000 s for an arrival rate of 10^{x} clients per hour (x is shown horizontally).

In the embodiment described above, the transmission schedule is maximally adaptive, in the sense that not only the decision whether or not a block is transmitted depends on whether or not a request occurs, but also the time unit in which the transmission is scheduled (as late as possible). In an alternative embodiment, the schedule of the blocks is fixed, and only the decision is made whether or not a block is transmitted. For fixed transmission schedules, block k is optimally transmitted once every o+k time units. If a request then occurs in a time unit t, there is exactly one transmission of block k scheduled that can be received in time. It is not possible to skip a transmission of block k and wait until the next one, as this next one is o+k time units later, and hence will be too late for playout. Whether or not block k should be transmitted, in its prescheduled time unit, now only depends on whether or not a request has occurred during the past o+k time units, which happens with probability
1−e^{-λu(o+k)},
and hence the average number of used channels is given by

$${\sum }_{k = 1}^{n} \frac{1 - {ⅇ}^{- λ u ( o + k )}}{o + k} .$$

Again, choosing the size u of a time unit very small, and assuming a maximum waiting time of w and length l of a movie, we have o≈w/u and n≈l/u, this gives an average number

$${\sum }_{k = 1}^{l / u} \frac{1 - {ⅇ}^{- λ ( w + u k )}}{( w + u k ) / u} .$$

For sufficiently small u this can again be approximated by

$${\int }_{0}^{l / u} \frac{1 - {ⅇ}^{- λ ( w + u x )}}{( w + u x ) / u} ⅆ x ,$$

which, using y=w+ux is equal to

$${\int }_{w}^{w + l} \frac{1 - {ⅇ}^{- λ y}}{y} ⅆ y .$$

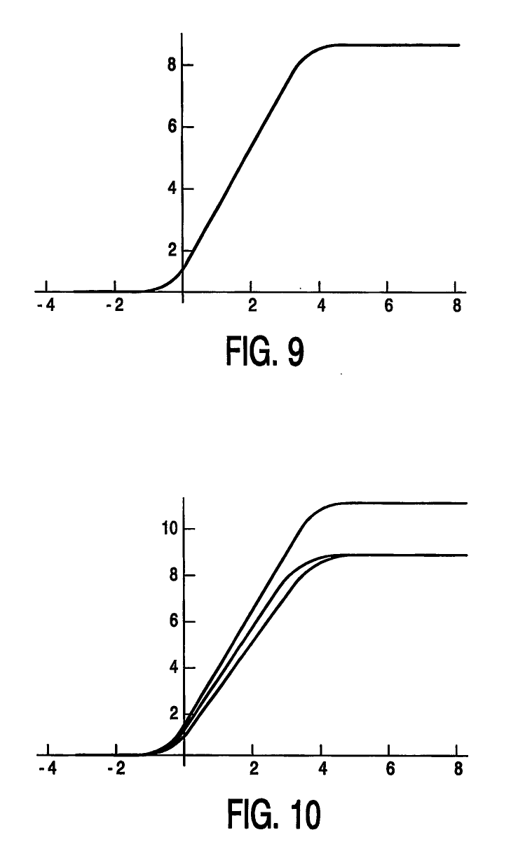

Note that the dependency on u has disappeared in this equation. The results obtained by the alternative embodiment are shown in FIG. 9. This figure shows the second bound on the average number of used channels (vertically) for the same maximum response time w=0.95 s and the same movie length l=6000 s for an arrival rate of 10 clients per hour (horizontally).

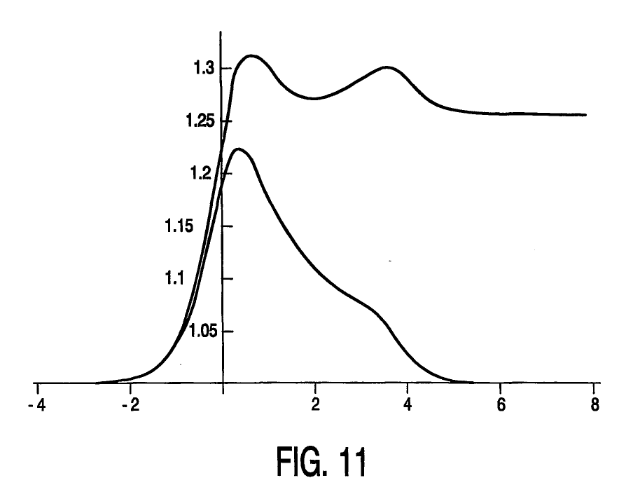

FIG. 10 combines the graphs of the average number of used channels of FIGS. 6, 8 and 9. The top line corresponds to the used selective pagoda scheme, the bottom line to the lower bound given by the fully adaptive scheme, and the middle line to the selective transmission with optimal periods. FIG. 11 shows the ratio between the top line and the lower bound and the ratio between the middle line and the lower bound. As can be seen, the selective pagoda scheme is always within 32% from the lower bound. The difference between the two lines indicates what can be gained by choosing a better NVoD schedule. To get below the second line, also the moments of transmission must become adaptive.

In the literature, several ways to lower the bandwidth requirement for unpopular movies have been proposed. One way is to use broadcasting only for the latter part of a movie, and transmit the first (small) part of a movie more or less on request, for each user individually. A drawback of this method is that popular movies require more bandwidth than with an all-broadcast approach. To overcome this, one should know the popularity of a movie, and choose the proper balance between the first, on-demand part and the latter, broadcasted part. Another way is to dynamically schedule block transmissions. Upon a request, one checks which blocks are still to come, and inserts the missing blocks in a dynamic way into the schedule. A drawback of this method is that a heuristic is used to schedule the blocks, which may perform worse than an optimal offline broadcast scheme. The benefit of the schedule according to the invention is that (asymptotically) optimal offline broadcast schemes can be used, and only on-line it needs to be determined whether or not a block should be broadcast. In this way, the required bandwidth automatically adapts to the popularity of a movie, and a (near) optimal solution is obtained for the entire popularity range.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in a claim. The invention can be implemented by means of hardware comprising several distinct elements, and by means of a suitably programmed computer. In the system claims enumerating several means, several of these means can be embodied by one and the same item of hardware. The computer program product may be stored/distributed on a suitable medium, such as optical storage, but may also be distributed in other forms, such as being distributed via the network of the broadcasting system, Internet or wireless telecommunication systems.

1. A broadcast system for broadcasting at least one title using a near-video-on-demand broadcasting protocol; the system includes:
a plurality of broadcast receivers;
a hierarchical network of data distributors starting from a central distributor through at least one layer of intermediate distributors to the broadcast receivers for broadcasting the title as a sequence of data blocks;
at least one filter controller operative to receive requests from broadcast receivers for the supply of the title and for controlling at least one intermediate distributor to filter out data blocks of the title that have not been requested by receivers hierarchically below the intermediate distributor.

2. A broadcast system as claimed in claim 1, wherein data blocks of the title are broadcast via a plurality of channels using sequential time-slots within the channels according to a near-video-on-demand schedule that for each data block of the title prescribes a time-slot and channel for broadcasting the data block relative to a time-slot used for broadcasting a first data block of the title; data blocks assigned to a channel being repeatedly broadcast within the channel; the filter controller being operative to:
store information on all receivers hierarchically below the intermediate distributor that have requested the title (hereinafter “interested receivers”) to enable the filter controller to determine for each channel whether at least one of the interested receivers needs to receive a data block assigned to the channel; and
control the intermediate distributor to filter out a channel if no interested receiver needs to receive a data block assigned to the channel.

3. A broadcast system as claimed in claim 2, wherein the near-video-on-demand schedule prescribes that data blocks of the title are broadcast via c parallel equal capacity channels of the broadcast system, where each broadcast channel is associated with a respective sequential channel number; the title being divided in a plurality of consecutive data block sequences; each block sequence being assigned to one respective channel according to the sequence of the channel numbers; each channel repeatedly broadcasting the blocks of the assigned block sequence; the broadcast receiver having a capacity to simultaneously receive a plurality r (1<r≦c) of the channels; the broadcast receiver being operative to receive a title by starting reception of the sequentially lowest r channels and each time in response to having received all blocks of the block sequence of a channel i terminate reception of channel i and start reception of channel r+i until all block sequences have been received.

4. A system as claimed in claim 3, wherein the near-video-on-demand schedule prescribes that data blocks of the title are broadcast via c parallel equal capacity channels of the broadcast system, where each broadcast channel is associated with a respective sequential channel number; a plurality of the broadcast channels including a plurality of time-sequentially interleaved sub-channels; the number of sub-channels in a channel being monotonous non-decreasing with the channel number; the sub-channels in a channel being associated with a respective sequential sub-channel number; the title being divided in a plurality of consecutive data block sequences; each block sequence being assigned to one respective sub-channel according to the sequence of the channel numbers and of the sub-channel numbers; each sub-channel repeatedly broadcasting the assigned block sequence; the broadcast receiver having a capacity to simultaneously receive all sub-channels of a plurality r (1<r≦c) of the channels; the broadcast receiver being operative to receive a title by starting reception of all sub-channels of the sequentially lowest r channels and each time in response to having received all blocks of the block sequence of a sub-channel of channel i terminating reception of the sub-channel in channel i and starting reception of a sub-channel of channel r+i until all block sequences have been received; the filter controller being operative to control the intermediate distributor to filter out a sub-channel if no interested receiver needs to receive a data block assigned to the sub-channel.

5. A system as claimed in claim 2, the filter controller is operative to use the stored information to determine for each channel whether at least one interested receiver needs to receive a data block in a next time-slot of the channel and to control the intermediate distributor to filter out the data block if no interested receiver needs to receive the data block in the next time-slot.

6. A system as claimed in claim 5, wherein the channels are time-multiplexed.

7. A system as claimed in claim 3, wherein the intermediate distributor is operative to extract data blocks broadcast via the r channels to be received by at least one interested receivers and transmit the extracted data blocks via predetermined channels to the interested receivers.

8. A system as claimed in claim 1, wherein the intermediate distributor includes the filter controller.

9. A system as claimed in claim 1, wherein at least one of the broadcast receivers is operative to communicate to the filter controller via an upstream channel of the broadcast system.

10. A method of broadcasting at least one title as a sequence of data blocks through a hierarchical network of data distributors starting from a central distributor through at least one layer of intermediate distributors to the broadcast receivers using a near-video-on-demand broadcasting protocol; the method including:
receiving requests from broadcast receivers for the supply of the title;
in at least one intermediate distributor filtering out data blocks of the title that have not been requested by receivers hierarchically below the intermediate distributor.

11. A broadcast receiver for use in a broadcast system as claimed in claim 1 that includes a hierarchical network of data distributors starting from a central distributor through at least one layer of intermediate distributors to the broadcast receivers for broadcasting a title as a sequence of data blocks using a near-video-on-demand broadcasting protocol via downstream channels of the system; the broadcast receivers being operative to communicate to a filter controller via an upstream channel of the broadcast system to enable the filter controller to control at least one intermediate distributor hierarchically above the broadcast receiver to filter out data blocks of the title that have not been requested by receivers hierarchically below the intermediate distributor.

12. A filter controller for use in a broadcast system as claimed in claim 1 that includes a hierarchical network of data distributors starting from a central distributor through at least one layer of intermediate distributors to the broadcast receivers for broadcasting a title as a sequence of data blocks using a near-video-on-demand broadcasting protocol via downstream channels of the system; the filter controller being operative to receive requests from broadcast receivers for the supply of the title and for controlling at least one intermediate distributor to filter out data blocks of the title that have not been requested by receivers hierarchically below the intermediate distributor.

13. An intermediate distributor for use in a broadcast system as claimed in claim 1 that includes a hierarchical network of data distributors starting from a central distributor through at least one layer of intermediate distributors to the broadcast receivers for broadcasting a title as a sequence of data blocks using a near-video-on-demand broadcasting protocol via downstream channels of the system; the intermediate distributor being operative to filter out data blocks of the title that have not been requested by receivers hierarchically below the intermediate distributor.
